(19) United States
(12) Patent Application Publication
(10) Pub. No.: US 2020/0012996 A1
(43) Pub. Date: Jan. 9, 2020

(54) INFORMATION PROCESSING APPARATUS AND INFORMATION PROCESSING METHOD

(71) Applicant: TOYOTA JIDOSHA KABUSHIKI KAISHA, Toyota-shi (JP)

(72) Inventors: Koseki SUGIYAMA, Suntou-gun (JP); Atsuko KOBAYASHI, Nagoya-shi (JP); Hiroki ASANO, Toyota-shi (JP); Harunobu SAITO, Nagoya-shi (JP); Yoshihiro TSUGE, Toyota-shi (JP); Tae SUGIMURA, Miyoshi-shi (JP); Kuniaki JINNAI, Nagoya-shi (JP)

(73) Assignee: TOYOTA JIDOSHA KABUSHIKI KAISHA, Toyota-shi (JP)

(21) Appl. No.: 16/452,715

(22) Filed: Jun. 26, 2019

(30) Foreign Application Priority Data
Jul. 4, 2018 (JP) 2018-127393

(51) Int. Cl. G06Q 10/06; G06Q 50/30; G01C 21/34; H04W 4/02

(52) U.S. Cl. CPC G06Q 10/063118; G06Q 50/30; H04W 4/02; G01C 21/343; G01C 21/3438

(57) ABSTRACT

The information processing apparatus includes a controller that acquires information indicating a travel plan of a user and information indicating a driving schedule of a car available for the use of rideshare, and transmits information recommending the use of rideshare to a terminal of the user when determining that the travel plan of the user is executable by the use of rideshare using the car based on the information indicating the travel plan of the user and the information indicating the driving schedule of the car.

### CROSS REFERENCE TO RELATED APPLICATION

This application claims priority to Japanese Patent Application No. 2018-127393, filed on Jul. 4, 2018, which is hereby incorporated by reference herein in its entirety.

### BACKGROUND

### Technical Field

The present disclosure relates to an information processing apparatus and an information processing method.

### Description of the Related Art

Recently, a transportation mode where a plurality of people share a ride on a same car has been gaining popularity. As a technique regarding sharing a ride with others (rideshare), there is a fellow-passenger search system formed with a management server storing information related to users and user terminals carried by the users, and the management server searches for a fellow passenger as another user who travels by sharing a ride on a car in response to the request of the user terminals (e.g., Patent document 1).

### CITATION LIST

### Patent Document

[Patent document 1] Japanese Patent Laid-Open No. 2014-146261

[Patent document 2] National Publication of International Patent Application No. 2013-513183

### SUMMARY

It is an object of the present disclosure to provide an information processing apparatus and an information processing method capable of expanding the use of rideshare.

An aspect of the present disclosure is an information processing apparatus including a controller that executes: acquisition of information indicating a travel plan of a user and information indicating a driving schedule of a car available for use of rideshare; and transmission of information recommending the use of the rideshare to a terminal of the user when determining that the travel plan of the user is executable by the use of the rideshare using the car based on the information indicating the travel plan of the user and the information indicating the driving schedule of the car.

Another aspect of the present disclosure is information processing method including: acquiring information indicating a travel plan of a user and information indicating a driving schedule of a car available for use of rideshare; and transmitting information recommending the use of the rideshare to a terminal of the user when determining that the travel plan of the user is executable by the use of the rideshare using the car based on the information indicating the travel plan of the user and the information indicating the driving schedule of the car.

Other aspects of the present disclosure are a program causing a computer to execute the information processing method described above and a recording medium to which the program is recorded.

According to the present disclosure, opportunities for using rideshare can be increased.

### BRIEF DESCRIPTION OF THE DRAWINGS

FIG. 1 is a diagram illustrating a configuration example of an information processing system according to a first embodiment;

FIGS. 2A and 2B are block diagrams, in which FIG. 2A illustrates a configuration example of an information processing apparatus (computer) applicable to a server and FIG. 2B illustrates a configuration example of the server;

FIGS. 3A and 3B are block diagrams, in which FIG. 3A illustrates a configuration example of an information processing apparatus (computer) that can be used as a first terminal and FIG. 3B illustrates a configuration example of the first terminal;

FIGS. 4A and 4B are block diagrams, in which FIG. 4A illustrates a configuration example of an information processing apparatus (computer) that can be used as a second terminal and FIG. 4B illustrates a configuration example of the second terminal;

FIG. 5 is a table illustrating a data configuration example of a user database;

FIG. 6 is a table illustrating a data configuration example of a car database;

FIG. 7 is a flowchart illustrating an operation example of the server;

FIG. 8 is a flowchart illustrating an example of user extraction processing;

FIG. 9 is a flowchart illustrating an example of available car search processing;

FIG. 10 is a flowchart illustrating processing of the first terminal when receiving recommend information;

FIG. 11 is a flowchart illustrating an operation example of the server;

FIG. 12 is a flowchart illustrating a processing example of the second terminal; and

FIG. 13 is a flowchart illustrates user extraction processing according to a second embodiment.

### DESCRIPTION OF THE EMBODIMENTS

With an information processing apparatus according to an aspect of the present disclosure, information for recommending the use of rideshare is transmitted to a terminal of a user when a travel plan of the user can be executed by the use of rideshare by using a car based on information indicating the travel plan of the user and information indicating a driving schedule of a car available for the use of rideshare. The user can have an opportunity to use rideshare upon receiving the information for recommending rideshare via the terminal. Then, when the user actually practices in rideshare, opportunities for using rideshare can be increased. The increase in the opportunities includes increase in the number of people actually having an experience in the use of rideshare and increase in a total number of rideshare users (increase in the number of use per person).

Hereinafter, the information processing apparatus and an information processing method according to embodiments of the present disclosure will be described by referring to the accompanying drawings. Configurations of the embodiments are examples, and the present disclosure is not limited to the configurations of the embodiments.

### First Embodiment

<System Configuration>

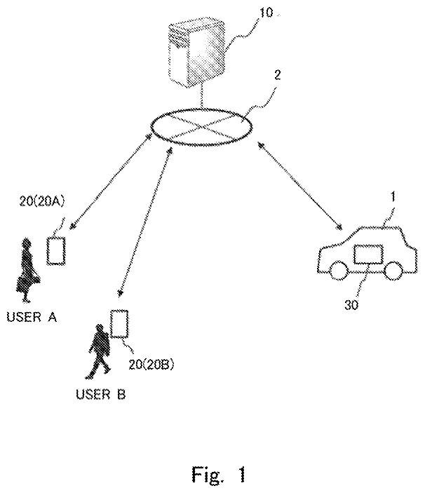

FIG. 1 is a diagram illustrating a configuration example of the information processing system according to a first embodiment. In FIG. 1, the information processing system includes a server 10, a first terminal 20, and a second terminal 30.

Each of the server 10, the first terminal 20, and the second terminal 30 can transmit and receive data through performing communication via a network 2. The network 2 includes WAN (Wide Area Network) that is a worldwide public communication network such as the Internet and an access network for WAN, for example. Note, however, that other communication networks than WAN may be employed as well. The access network may be a wire network (e.g., LAN) or a radio network. The radio network is a radio network satisfying or conforming to a prescribed radio communication standard (Radio Access Technology (RAT)). Examples of the radio communication standard (RAT) may be cellular communication standard such as 3G, LTE (Long Term Evolution), or 5G, radio LAN (including IEEE 802.11 series, WiFi), Bluetooth®, BLE (Bluetooth® Low Energy), and CV2X (Cellular Vehicle-to-Everything).

The first terminal 20 is a communication terminal used by a user of a rideshare service. Further, the second terminal 30 is used by a driver of a car 1 that can be used for rideshare by the user of the rideshare service and a caretaker of the car 1.

The server 10 manages information related to the rideshare service using the car 1. The server 10 collects and manages information related to the users of the rideshare service and information related to the car 1. In the present embodiment, the users of the rideshare service are not only the users with an actual use experience but also latent users without use (with no actual use experience). The users belong to a group taking the users of the rideshare service as members, and the server 10 manages the information related to the members of the group.

In FIG. 1, a first terminal 20A used by a user A and a first terminal 20B used by a user B are illustrated as examples of the first terminal 20. Note, however, that the number of the first terminal 20 may be one, or three or more. Also, while FIG. 1 illustrates only one each of the car 1 and the second terminal 30, there may be two or more of the cars 1 and the second terminals 30.

The first terminal 20 is a small (portable) computer, for example. The first terminal 20 includes a smartphone, a tablet computer, a mobile computer, a wearable computer, a wireless storage, a feature phone, a handy terminal, and a laptop personal computer. The first terminal 20 may be a general-purpose computer or a special-purpose computer. Further, the first terminal 20 may be a fixed terminal or an onboard terminal in some cases.

Also, the second terminal 30 may be a general-purpose computer or a special-purpose computer. Further, the second terminal 30 may be a mobile terminal or fixed terminal. The types of computers indicated as the examples of the first terminal may be applied to the second terminal 30.

The present embodiment will be described by referring to a case where the first terminal 20 is a smartphone carried and used by the user and the second terminal 30 is an onboard terminal loaded on the car 1. The second terminal 30 as an onboard terminal may be fixed (built-in) to the car 1, may be mounted detachably to the car 1 and capable of being taken out from the car as needed, or may be a portable computer simply placed at a prescribed position inside the car 1.

In the present embodiment, the server 10 manages information related to the user of the rideshare service, and the information related to the user includes information (actual experience information) indicating whether or not the user has actual experience in the use of rideshare. The server 10 specifies the user with no actual experience in the use of rideshare according to the actual experience information, and transmits information (recommend information) for recommending the use of rideshare to the terminal (first terminal 20) of such user. However, it is not indispensable to limit destination of the recommend information to the user with no actual experience in the use of rideshare. For example, in a case where a certain user exclusively uses the rideshare service for traveling to a certain place but not for places other than that certain place, the recommend information may be transmitted for recommending rideshare also to the places other than the certain place. In such case, it is also possible to increase frequencies in the use of rideshare and expand opportunities for the use of rideshare.

In the present embodiment, as a way of example, the server 10 manages a user database (user DB) that manages information related to the users of the rideshare service and a car database (car DB) that manages information related to the cars 1 that can be used by the users for rideshare.

The server 10 uses the information stored in the user DB (actual experience information) indicating whether or not the user has actual experience in the use of rideshare to specify the user with no actual experience in the use of rideshare, and acquires information (schedule) indicating a travel plan of such user. The schedule may be stored in advance in the user DB or may be acquired from somewhere other than user DB (e.g., the first terminal 20). Further, the schedule may be generated by predicting future traveling from a history of positions of the user in the past.

Further, the server 10 acquires a driving schedule of the car 1 that can be used for rideshare. The schedule may be stored in the car DB or may be acquired from the second terminal 30.

Note that the present embodiment will be described by referring to a case where an operator of the rideshare service as a manager of the server 10 is also a car dealer or a case where a car dealer is a cooperator. The car dealer operates various kinds of services for a group of private car owners (referred to as a car owner group) among customers of the car dealer, and manages the database related to the members of the car owner group (car owner DB). In the present embodiment, the user of the rideshare service is a person who agrees to be a member of a group of users of the rideshare service (referred to as a rideshare user group) among the members of the car owner group. Therefore, the user DB in the present embodiment is generated based on the information stored in the database (referred to as the car owner DB) generated regarding the members of the car owner group. Further, the car 1 is one of the private cars of the users of the rideshare service.

Note, however, that the case of the present embodiment described above is an example, and it is not indispensable for the manager of the server 10 to undertake a business other than the operation of the rideshare service. Further, the business other than the operation of the rideshare service may be a business other than the car dealer. Also, it is not indispensable for the user of the rideshare service to be an owner of a private car (not indispensable for the car 1 to be the private car of the user of the rideshare service). The user of the rideshare service may be a person who does not own a private car.

Hereinafter, configuration examples of the server 10, the first terminal 20, and the second terminal 30 will be described.

### <Configuration of Server>

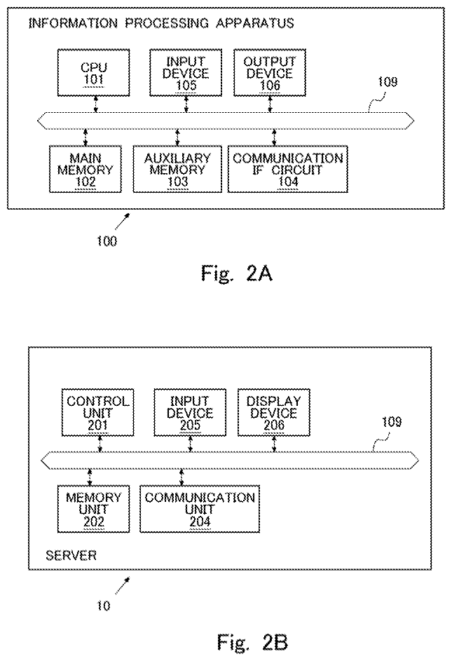

FIG. 2A illustrates a configuration example of the information processing apparatus (computer) 100 applicable to the server 10. FIG. 2B illustrates a configuration example of the server 10. Referring to FIG. 2A, in the information processing apparatus 100, a CPU (Central Processing Unit) 101, a main memory 102, an auxiliary memory 103, a communication interface circuit (communication IF circuit) 104, an input device 105, and an output device 106 are connected mutually via a bus 109. The CPU 101 is an example of a processor, and the main memory 102 and the auxiliary memory 103 are examples of a memory.

The main memory includes a RAM (Random Access Memory) and a ROM (Read Only Memory). The RAM is used as an expansion area of programs, a work area of the CPU 101, a data memory area, and the like. The ROM stores various programs executed by the CPU 101 and the data used when executing the programs. The auxiliary memory 103 stores the programs, the data, and the like used when executing the programs. An example of the auxiliary memory 103 is a hard disk drive (HDD).

The communication IF circuit 104 is a circuit taking in charge of communication processing in accordance with a prescribed communication standard, and executes signal transmission and reception, protocol conversion processing, and the like. The input device 105 may be keys, buttons, a pointing device, a touch panel, or the like used for inputting information. Further, the output device 106 is used for outputting information. The output device 106 includes a display device, a printer, and the like. Also, the input device 105 may include a sound input device such as a microphone in some cases. The output device 106 may include a sound output device such as a speaker in some cases. As a sound input and output device, a headset may be used, for example.

The CPU 101 performs various kinds of processing by loading and executing the programs stored in the main memory 102 and the auxiliary memory 103. With execution of the programs by the CPU 101, the information processing apparatus 100 operates as the server 10 that includes a control unit 201, a memory unit 202, a communication unit 204, an input device 205, and a display device 206 connected mutually via the bus 109 as illustrated in FIG. 2B.

The CPU 101 operates as the control unit 201. The main memory 102 and the auxiliary memory 103 are used as the memory unit 202. The communication IF circuit 104 operates as the communication unit 204 (FIG. 2B), and the input device 105 and the output device 106 are used as the input device 205 and the display device 206.

The control unit 201 performs following operations or processing, for example, as the processing for controlling rideshare using the car 1.

(a) Acquire information indicating the travel plan of the user and information indicating the driving schedule of the car available for the use of rideshare.

(b) Transmit information recommending use of rideshare to a terminal of the user, when determining that the travel plan of the user can be executed by the use of rideshare using the car based on the information (schedule) indicating the travel plan of the user and the information indicating the driving schedule of the car.

### <Configuration of First Terminal>

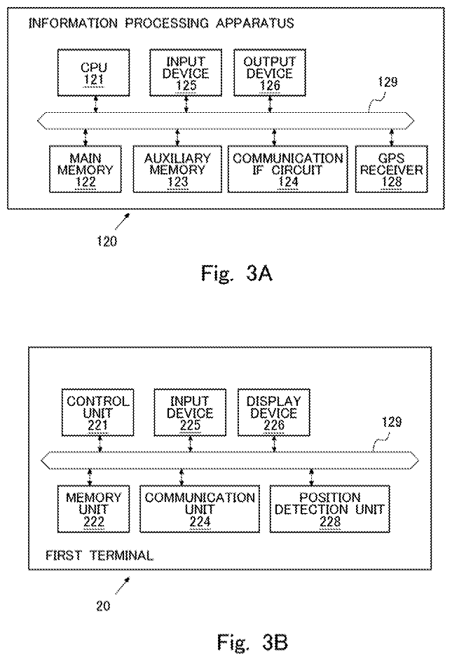

FIG. 3A illustrates a configuration example of an information processing apparatus (computer) 120 that can be used as the first terminal 20. FIG. 3B illustrates a configuration example of the first terminal 20. Referring to FIG. 3A, like the information processing apparatus 100, the information processing apparatus 120 has the configuration in which a CPU 121, a main memory 122, an auxiliary memory 123, a communication IF circuit 124, an input device 125, and an output device 126 are connected mutually via a bus 129. Further, a GPS (Global Positioning System) receiver 128 is connected to the bus 129 of the information processing apparatus 120. The GPS receiver 128 is used for detecting the position of the first terminal 20, i.e., current position of the user.

In the information processing apparatus 120 illustrated in FIG. 3A, the CPU 121 executes the programs stored in the main memory 122 and the auxiliary memory 123. Thereby, the information processing apparatus 120 operates as the first terminal 20 including a control unit 221, a memory unit 222, a communication unit 224, an input device 225, a display device 226, and a position detection unit 228 as illustrated in FIG. 3B. That is, the CPU 121 operates as the control unit 221. The main memory 122 and the auxiliary memory 123 are used as the memory unit 222. Further, the communication IF circuit 124 operates as the communication unit 224. Further, the input device 125 and the output device 126 are used as the input device 225 and the display device 226. Also, the GPS receiver 128 operates as the position detection unit 228.

<Configuration of Second Terminal>

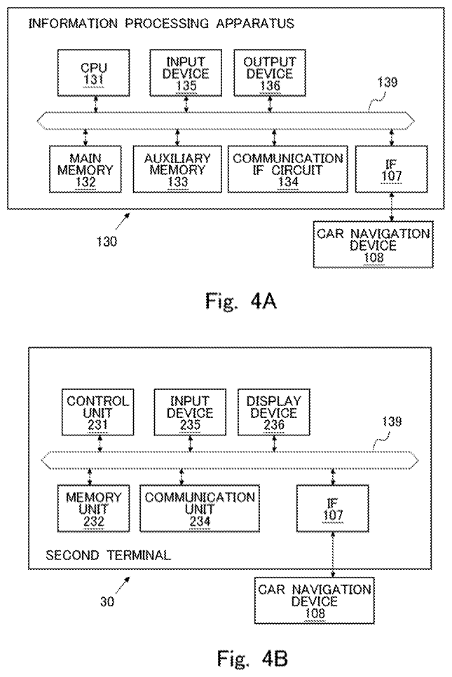

FIG. 4A illustrates a configuration example of an information processing apparatus (computer) 130 that can be used as the second terminal 30. FIG. 4B illustrates a configuration example of the second terminal 30. Referring to FIG. 4A, the information processing apparatus 130 has the configuration in which a CPU 131, a main memory 132, an auxiliary memory 133, a communication IF circuit 134, an input device 135, and an output device 136 are connected mutually via a bus 139.

In the information processing apparatus 130 illustrated in FIG. 4A, the CPU 131 executes the programs stored in the main memory 132 and the auxiliary memory 133. Thereby, the information processing apparatus 130 operates as the second terminal 30 including a control unit 231, a memory unit 232, a communication unit 234, an input device 235, and a display device 236 as illustrated in FIG. 4B. That is, the CPU 131 operates as the control unit 231. The main memory 132 and the auxiliary memory 133 are used as the memory unit 232. Further, the communication IF circuit 134 operates as the communication unit 234. Further, the input device 135 and the output device 136 are used as the input device 235 and the display device 236.

Further, the information processing apparatus 130 may be connected to a car navigation device 108 loaded on the car 1 via an interface circuit (IF) 107. The car navigation device 108 includes a CPU (processor), a memory, a communication device, a GPS receiver, an input device, a display device, and the like. Through execution of the programs stored in the memory, the processor calculates distance, route, time needed, from the current position to a destination acquired from destination information inputted from the input device and from the GPS receiver, and displays a map including the position of the car 1 on the display device. Along with the map, the car navigation device 108 displays the distance to the destination, route, time needed, and the like. Further, when the distance between the current position and the destination becomes shorter than a prescribed distance, the processor notifies the driver of the car 1 to be in a neighborhood of the destination by outputting a voice or changing a display mode. The second terminal 30 can use the information acquired by the car navigation device 108 when generating the information related to the car 1. When the second terminal 30 is an onboard terminal, it is possible to implement the second terminal 30 by expanding functions of the car navigation device 108 or an existing communication terminal loaded on the car 1.

<Database (DB)>

Hereinafter, the database used or managed by the server 10 will be described. The database described hereinafter is stored in the memory unit 202 of the server 10. Note, however, that the database may be stored in a memory other than the memory unit 202 inside or outside of the server 10.

<<User DB>>

A user DB 151 is a DB for storing information related to the user of the first terminal 20. The user DB 151 corresponds to “database accumulating information related to the use of rideshare related to each member of a prescribed group”.

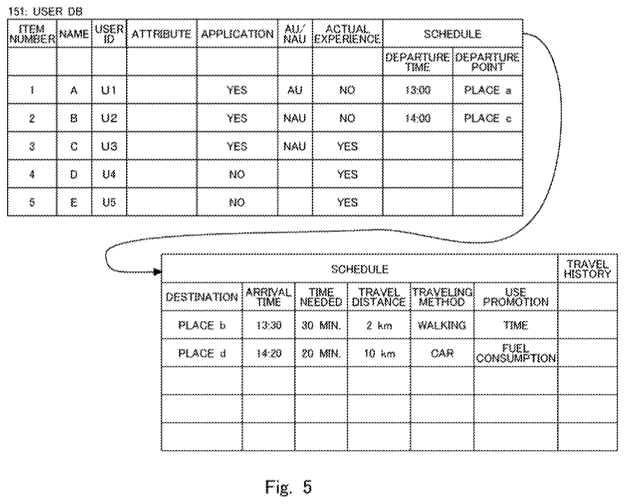

FIG. 5 is a diagram illustrating a configuration example of data in the user DB 151. Referring to FIG. 5, the user DB 151 has a table configuration storing one entry (record) or more corresponding to the user. In the example of FIG. 5, as information elements, the record includes “name”, “user ID”, “attribute”, “application”, “AU (Active User)/NAU (Non-Active User)”, “actual experience”, “schedule”, and “travel history”.

“Name” is a full name or a title of the user of the first terminal 20. “User ID” is a unique identifier (user ID) of the user. “Attribute” is the information indicating the attribute of the user. “Attribute” information includes personal information of the user, information related to the first terminal 20 used by the user, information (private car related information) related to the car (private car) owned by the user, and the like.

The personal information of the user is at least one selected from sex, age, name, address, contact information, occupation, and the like of the user, for example. Further, the information related to the first terminal 20 is at least one selected from the address of the first terminal 20, identifier (terminal ID) of the first terminal 20, and the like, for example. Note, however, that the elements of the information related to the personal information and the first terminal 20 are not limited to those elements listed above.

Further, examples of the private car related information may be model of the private car, fuel consumption (consumption amount of gasoline or diesel or consumption amount of electricity per unit running distance), and discharge amount of carbon dioxide (CO₂) per unit running distance. The private car is a mobile body including a motor such as an engine, and example of the private car may be a motorcar (including a motorcycle with a displacement of 50 cc or more) and a motorbike with a displacement of less than 50 cc. Note that information items of the private car related information are not limited to the items listed above.

“Application” is the information indicating whether or not there is an application program (referred to as “rideshare application”) used for concluding a contract regarding the use of the rideshare service installed in the first terminal 20 used by the user. The rideshare application is an example of “software regarding use of rideshare”.

It is encouraged or recommended to install the rideshare application at an opportunity of acknowledging or suggesting user registration (registration of record to the user DB 151) of the rideshare service when purchasing the private car described above, for example. In response to an approach (request) to install, the user can download and install the rideshare application through accessing to a download site of the rideshare application by using the first terminal 20. Note, however, that the request for downloading and installing the rideshare application may be made not only by the manner described above but also by using an advertisement by a broadcast transmission from the server 10 or the second terminal 30 (onboard terminal), for example.

“AU/NAU” indicates whether the user is an active user (AU) or a non-active user (NAU) of the rideshare application. Herein, the user who has installed the rideshare application to the first terminal 20 but has no actual experience in the use of the rideshare application or the user who has actual experience in the use of the rideshare application but has no actual experience in the use of the rideshare service (no record of concluding a contract) is defined as “NAU”. In the meantime, the user having a record of concluding a contract of the rideshare service using the rideshare application is defined as “AU”.

“Actual experience” indicates whether or not the user has actual experience in using the rideshare service determined by using “application” and “AU/NAU”. The user who has no installation of the rideshare application and the user corresponding to “NAU” are determined as the user with no actual experience.

Note here that the rideshare application is executed by the control unit 221 (CPU 121 operating as the control unit) of the first terminal 20. The rideshare application includes a first flag indicating “Yes” in actual use experience of the rideshare application and a second flag indicating “Yes” in actual use experience of the rideshare service, for example. When the rideshare application is started up in the first terminal 20 and a history of information inputted by the user through operating the rideshare application is formed, the first flag is set. Further, when the rideshare application is used and use of the rideshare service is settled (e.g., when the user registers completion of the use of the rideshare service), the second flag is set.

At least one out of a notification indicating completion of installation of the rideshare application, a notification indicating completion of setting the first flag, and a notification indicating completion of setting the second flag can be transmitted to the server 10 via the communication unit 224 (communication IF circuit 124). The rideshare application includes the address (prescribed destination address) of the server 10, and each of the above-described notifications is transmitted to that address. Each of the notifications includes ID of the rideshare application (application ID), ID of the user (user ID) of the first terminal 20, terminal ID of the first terminal 20, and the address of the second terminal.

Upon receiving the notification from the communication unit 204 (communication IF circuit 104), the control unit 201 (CPU 101 operating as the control unit) of the server 10 updates the user DB 151 according to the notification. For example, when the notification indicates completion of installation of the rideshare application, “application” in the source DB is set (updated) to “Yes” in the corresponding record. In the meantime, when the notification indicates completion of setting the first flag or completion of setting the second flag, the control unit 201 sets (updates) the value of AU/NAU to “AU”. In the present embodiment, either the notification of completion of setting the first flag or the notification of completion of setting the second flag may be transmitted for controlling the value of AU/NAU, and transmission of the other can be omitted. Which one is to be omitted can be set by the user as appropriate.

“Schedule” is an example of the information indicating the travel plan of the user, and indicates, for example, the travel plan of the user in a prescribed period (e.g., one day, in the morning, or in the afternoon). As parameters (information items), “schedule” can include “departure time”, “departure point”, “destination”, “arrival time”, “time needed”, “travel distance”, “traveling method”, “use promotion information” and the like. “Schedule” can record each of one, two, or more travel plans in the prescribed period (e.g., one day).

In “schedule”, “departure time” is the time planned to start traveling. “Arrival time” is the time planned to arrive at the destination. The time may include date, seven days of the week, and month in some cases. “Departure point” and “destination” are information indicating places and positions of start point and end point of the travel of the user. Granularity (degree of details) of such information can be determined as appropriate. Time needed is the time allotted to the travel from the departure point to the destination. “Travel distance” indicates the distance from the departure point to the destination. The distance may be direct distance, travel route distance, or a value acquired from a traveling speed and time needed by determining in advance the traveling speed per unit time according to the traveling method. “Traveling method” indicates a means used by the user for traveling, and examples may be walking, non-motorized car (bicycle), private car, and use of public transportations (train, bus, taxi, and the like).

“Use promotion information” includes the information indicating economic effects and social effects acquired (enjoyed) by changing the traveling method to rideshare (substituting with rideshare) and other information that can be an incentive to the user. Use promotion information may include information indicating free time (saved time) increased by changing to rideshare from walking or from use of a non-motorized car, information indicating reduction amount of fuel consumption or reduction amount of CO₂ achieved by the use of rideshare, information indicating contribution to preventing traffic jams and resolving traffic jams, and the like.

Note that the reduction amount fuel consumption and the reduction amount of CO₂ can be calculated by using the information related to the car in “attribute” information, travel time, and a prescribed calculation formula (stored in the memory unit 202). The information indicating the contribution by resolving the traffic jams is recorded when there is a possibility that traveling of the user may cause a traffic jam or a possibility of deteriorating condition of the traffic jam. The saved time can be calculated by using a prescribed calculation formula by using the traveling speed of walking, a non-motorized car, or a motorcar and road information.

An example of the information that may become an incentive is information capable of decreasing the risks while driving. It is considered to provide information indicating that risks for the user oneself while driving, such as poor physical and mental conditions, bad weather, poor visibility such as the dusk, traffic jam, trouble in the private car, and the like, can be decreased by the use of rideshare. It is also possible to select content of risks that can be avoided by the use of rideshare in accordance with the condition of the user, condition of the weather, condition of the road, time zone, and the like.

“Travel history” indicates actual experience of past traveling (activity history) of the user. “Travel history” indicates positions of the first terminal 20 of the user at each time (position shift path (traveling route)) in a prescribed period (e.g., one day) and the traveling speed. The travel history includes information indicating one, two or more kinds of traveling (going to work, going to school, going shopping, and the like) in accordance with activities of the user carrying the first terminal 20. Also included is information indicating behaviors in accordance with information indicating the traveling methods (walking, use of a non-motorized car, use of a private car, use of public transportations) regarding each kind of traveling.

Through assuming that the traveling specified from the travel history is repeated in a prescribed future (e.g., next day), such traveling specified from the travel history can be taken as a future travel plan of the user, i.e., as “schedule”. In other words, “schedule” can be generated from the travel history. When a plurality of kinds of traveling are included in the travel history, it is possible to generate the information indicating “schedules” (travel plans) corresponding to each kind of such traveling.

In fact, “schedule” can be acquired irrespective of the travel history. For example, the server 10 may make an inquiry about the schedule to the first terminal 20 as needed and acquire the schedule transmitted from the first terminal 20. Thus, it is not indispensable for the server 10 to record and manage the travel history. It is to be noted that the method of classifications (grouping, dividing) of the information elements illustrated in the user DB 151 of FIG. 5 is an example, and the method is not limited to such example.

A part of the information stored in the user DB 151 can be acquired (extracted) from a database (DB) other than the user DB 151 such as a DB related to a prescribed group. Such DB is referred to as an extraction source DB. In the present embodiment, described is a case where the car owner DB related to the car owner group described above is the extraction source DB. The user DB 151 includes information items in common to the information items stored in the car owner DB, and the information extracted from the car owner DB is stored. For example, “name”, “user ID”, “attribute” in the user DB 151 may be extracted from the car owner DB. Further, “application”, “AU/NAU”, “schedule”, “travel history” may be managed by the car owner DB and acquired from there. It is also possible to employ a configuration where the car owner DB stores all the information items held in the user DB 151, i.e., the user DB 151 may be a part of the car owner DB. The information elements stored in the user DB 151 are acquired from the first terminal 20 and a device other than the first terminal 20 regardless of the source of the information and the route of acquisition.

“Travel history” is acquired as follows, for example. The control unit 201 of the server 10 communicates with the first terminal 20 of each user regularly or periodically, and receives the position of the first terminal 20 (acquired by the position detection unit 228) from the first terminal 20. The control unit 201 acquires and records the travel distance and traveling speed from the position of this time and the position of previous time. Thereby, the travel route (changes in position coordinates) and the traveling speed of the first terminal 20 can be grasped.

<<Car DB>>

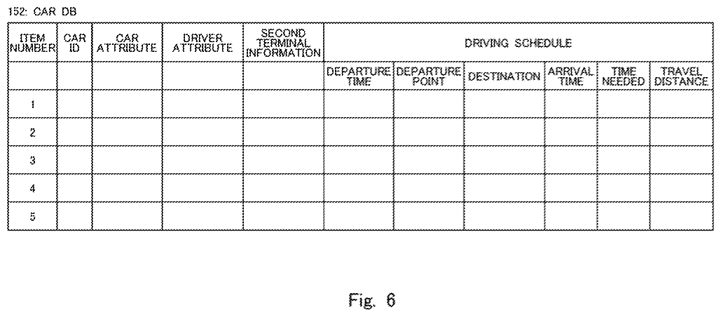

The car DB 152 is a DB for storing the information related to the car 1 that can be used for rideshare. FIG. 6 is a table illustrating a data configuration example of the car DB 152. Referring to FIG. 6, the car DB 152 has a table structure that stores one or more entries (records). The entries include “car ID”, “car attribute”, “driver attribute”, “second terminal information”, and “driving schedule” as the information elements. Note, however, that information items other than those may be included as well.

“Car ID” is specific information (car identifier) of the car 1. “Car attribute” is the information indicating the attribute of the car 1. Examples of the information items (car attributes) of the car attribute information may be car model (sedan, minivan, station wagon, truck, light car, ecocar, or the like) and luggage storage space (platform, trunk, or the like). Image information related to the car 1 may be included in the car attribute information.

“Driver attribute” is the information indicating the attribute of the driver of the car 1. Examples of the information items (attributes of the driver) of the driver attribute information are sex, age, and occupation of the driver. The driver attribute may include human race and use language. “Second terminal information” indicates the information related to the second terminal 30 associated with (corresponding to) the car 1. The second terminal information may be the identifier (ID) of the second terminal 30 and the address of the second terminal 30, for example.

“Driving schedule” indicates the schedule of traveling by driving the car 1 in a prescribed period (e.g., one day). The driving schedule may include parameters such as “departure (planned) time”, “departure point”, “destination”, “arrival (planned) time”, “time needed”, and “travel distance” along with the schedule of the user DB 151. “Departure time” and “departure point” may be a future planned time and current position of the car 1 (position of the car 1 at current time). The server 10 can acquire the current position of the car 1 from the second terminal 30 loaded on the car 1 or the car navigation device 108, for example. The information elements stored in the car DB 152 are acquired from the second terminal 30 and a device other than the first terminal 20 regardless of the source of the information and the route of acquisition.

Note that the car DB 152 may be a part of an existing DB such as the car owner DB or may be an independent DB generated by extracting needed information from the car owner DB.

The driving schedule may be registered in advance to the server 10 by the user by using the second terminal 30. Also, the control unit 201 of the server 10 may request the second terminal 30 to provide the driving schedule, and the driving schedule from the second terminal 30 in response to the request may be registered to the corresponding record of the car DB 152. The schedule information acquired from the second terminal 30 may be the information generated independently by the second terminal 30 or may be navigation information acquired by the second terminal 30 from the car navigation device 108 of the car 1.

### Operation Example

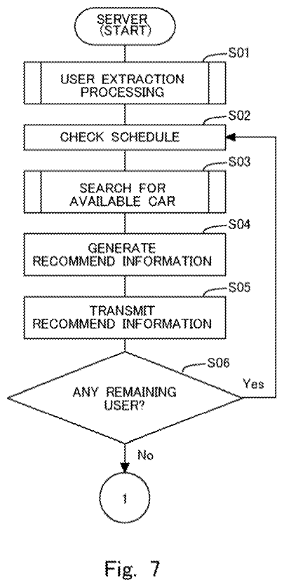

FIG. 7 is a flowchart illustrating an operation example of the server 10. The flowchart in FIG. 7 is executed by the control unit 201 of the server 10, for example. In S01, the control unit 201 executes user extraction processing for transmitting recommend information.

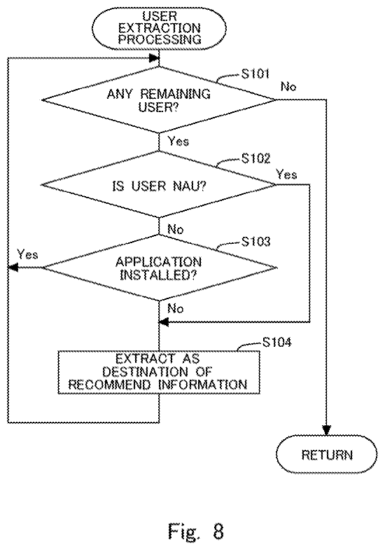

FIG. 8 is a flowchart illustrating an example of the user extraction processing. In S101, the control unit 201 refers to the user DB 151, and determines whether or not there are records of the remaining users. When determining that there are the remaining records, the control unit 201 specifies the record of one of the users from the user DB 151 and proceeds the processing to S102. If not, the user extraction processing is ended, and the processing is proceeded to S02.

In S102, the control unit 201 refers to the value of “AU/NAU” in the record specified in S101 and determines whether or not the value indicates NAU (non-active user). When determining that the value indicates NAU (Yes in S102), it is considered that the user has no actual experience in the use of rideshare. In such case, the user is determined as the destination for providing the recommend information, and the control unit 201 extracts the record of the user from the user DB 151 (S104). Thereafter, the processing is returned to S101. In the meantime, when determining that the value of “AU/NAU” is not NAU (No in S102), the control unit 201 proceeds the processing to S103.

In S103, the control unit 201 determines whether or not “application” in the record indicates “Yes”, i.e., indicates that the rideshare application has already been installed in the first terminal 20. Then, when determining that there is the rideshare application being installed (Yes in S103), the control unit 201 returns the processing to S101. That is, it is considered that the user has actual experience in the use of rideshare. In the meantime, when determining that there is no rideshare application being installed (No in S103), the processing is proceeded to S104.

In this manner, the processing of S102 to S104 is executed for all the users registered in the user DB 151, and the record of the user determining as having no actual experience in the use of rideshare is extracted. When the user extraction processing is ended, the processing is proceeded to S02 (FIG. 7).

In S02, the control unit 201 executes checking processing of the schedule. This processing is executed as follows.

((Method 1) Check Schedule Information in Record)

The control unit 201 specifies one user (record of the user) from the records of one, two or more users extracted by the processing of S01. The control unit 201 refers to the schedule stored in the record of the specified user.

((Method 2) Generate Schedule Information)

For example, when the travel history stored in the record of the user indicates an activity history of the user in a prescribed period (e.g., one day) and it is assumed that the same activities are to be repeated the next day (when a future travel can be predicted from the past travel history), the schedule of the user can be generated from the travel history.

The travel history includes information indicating a single or a plurality of kinds of traveling of the user. The information indicating the traveling included in the travel history can be extracted as follow. For example, when a pattern where the position of the first terminal 20 stops within a small area (inside a building or facility) for more than a prescribed length of time and then starts to move out from the small area is found, the control unit 201 determines that the user starts to travel, and sets the time at which the position leaves from the small area as the date and time (departure time) included in “Schedule” and position of the small area as “departure point”.

Thereafter, when the position of the first terminal 20 moves and stays in a small area for a prescribed length of time, the control unit 201 sets the position of the small area as “destination” in the travel history. Further, the control unit 201 sets the arrival time at the small area as the arrival time at the destination, acquires a difference with respect to the traveling start time and sets the difference as “time needed”. Further, the control unit 201 estimates the traveling method of the user by using the travel route and traveling speed of the position from the departure point to the destination and the travel pattern information described above, and sets the estimated method in “the traveling method”. The control unit 201 sets types of the information indicating the social contribution and economic effects corresponding to the traveling method in “use promotion information”. The distance from the departure point to the destination can further be included in the schedule. In this manner, one, two or more travel plans (schedules) can be generated from the travel history.

((Method 3) Acquire from First Terminal 20)

The schedule may be acquired from the first terminal 20. For example, the control unit 201 makes an inquiry to the user of the first terminal 20 about the travel schedule of the day. For example, the control unit 201 generates a message (including user ID) for inquiring the schedule, and transmits to the address of the first terminal 20 via the communication unit 204. The message is received by the first terminal 20 via the network 2.

In the first terminal 20, the control unit 221 provides the user with a schedule inquiry screen (e.g., displays on the display device 226). The user uses the input device 225 to input information items (departure point, destination, departure time, arrival time, and the like) related to generation of one, two or more schedules. The control unit 221 generates a response message including the schedule information inputted by the user, and transmits to the address of the server 10 from the communication unit 224. The response massage is received by the server 10 via the network 2. The control unit 201 of the server 10 acquires the schedule in the response massage, and registers to the record corresponding to the user ID. As described, in S02, the control unit 201 acquires the schedule by using any one of the methods 1 to 3 described above and checks the content.

In S03, the control unit 201 searches for the car 1 used for rideshare having the driving schedule capable of corresponding to the schedule. As described, the records of the cars 1 that can be used for the rideshare service are stored in the car DB 152 (FIG. 6). The control unit 201 refers to the driving schedules in each of the records of the car DB 152.

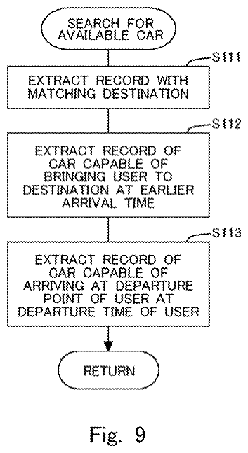

FIG. 9 is a flowchart illustrating an example of available car search processing. In S111, the control unit 201 of the server 10 compares the destination in the schedule in the record of the user (referred to as user schedule) extracted from the user DB 151 with the destinations in the driving schedules of each of the records in the car DB 152, and extracts the records with the driving schedules of matching destinations in order to select the cars 1 that need no great change in the driving schedules of the cars 1 because of rideshare. Matching destinations may include the following cases. However, these cases are not limitative.

(1) Case where the distance between the destinations is a prescribed threshold value or less.

(2) Case where the distance between the destination of the user and the travel route of the car 1 is a prescribed threshold value or less.

(3) Case where the destination of the user belongs to an area where the destination or via-points of the car 1 belong.

In S112, the control unit 201 extracts the record including the driving schedule with earlier arrival time than the arrival time of the user schedule from the records extracted in S111 in order to select the cars 1 of a smaller disadvantage for the user in terms of time by the rideshare. Note, however, that the record with the arrival time later than the arrival time in the user schedule but the delaying time length shorter than a prescribed time length may be included as an extraction target.

In S113, the control unit 201 extracts the record including the driving schedule capable of arriving at the departure point of the user at the departure time of the user in order to guarantee to pick up the user without delay. For example, the control unit 201 acquires the distance between the departure point in the schedule of the user and the departure point in the driving schedule, and extracts the record of the car 1 whose time needed for traveling the distance at an average traveling speed is shorter than the time from the current time to the departure time of the user. When the processing of S113 is ended, the processing is returned to S04.

Note that the order of S111 to S113 can be changed as appropriate. Further, at least one selected from the processing of S111 to S113 may be executed in S03.

In the processing of S03, it is also possible to transmit the schedule information of the user to a plurality of second terminals 30, wait for the second terminal 30 returning a replay indicating to be capable of providing rideshare, and generate the recommend information upon receiving such reply. When no available car 1 is searched in S03, the processing of the server 10 illustrated in FIG. 7 is ended.

In S04, the control unit 201 generates the recommend information for the user. The recommend information can include the following information.

(1) Information indicating that the traveling method employed for traveling to the destination of the user can be substituted by using the rideshare service (recommending the use of rideshare for traveling to the destination: corresponding to information recommending the use of rideshare).

(2) Travel schedule capable of using the rideshare (e.g., travel to destination XX).

(3) Use promotion information according to the traveling method.

(4) Information related to the car (car attribute information, drive attribute information).

(5) User ID, car ID (for a plurality of cars when there are).

The use promotion information is generated as appropriate according to the traveling method before changing to rideshare and the type of the use promotion information corresponding to the traveling method. For example, when changing from the use of private car to rideshare, it is set in the use promotion information that the fuel consumption and the CO₂ produced amount can be reduced through calculating the fuel consumption and CO₂ produced amount by using the information related to the private car and the travel distance in the schedule. Note, however, that it is not indispensable to generate the use promotion information in association with the traveling method but simply needs to present advantages acquired by increasing the opportunities for using rideshare even though the use promotion information is not directly related to the user. Thus, it is considered to select the use promotion information randomly to be included in the recommend information.

Note that the use promotion information and the information related to the car (at least one of the car attribute information and the driver attribute information) are optional. Further, when a plurality of cars 1 are searched in S03, the car attributes and driver attributes of all the searched cars 1 may be included, or the car attribute and driver attribute of at least one car 1 selected from the searched cars 1 may be transmitted.

In S05, the control unit 201 executes transmission processing of the recommend information. While the recommend information including a plurality of kinds of information (information of (1) to (4)) described above is generated and transmitted to the first terminal 20 in the present embodiment, the information of (1) to (4) may be transmitted separately in two or more times.

The recommend information is transmitted to the address of the first terminal 20 of the user from the communication unit 204. In S06, the control unit 201 determines whether or not (records of) a plurality of users are extracted in S01 and any unprocessed user record is remained. When determining that there is no remaining record, the processing is proceeded to S07. If not, the processing is returned to S02, and the processing of S02 to S05 regarding each of the remaining user records is repeated.

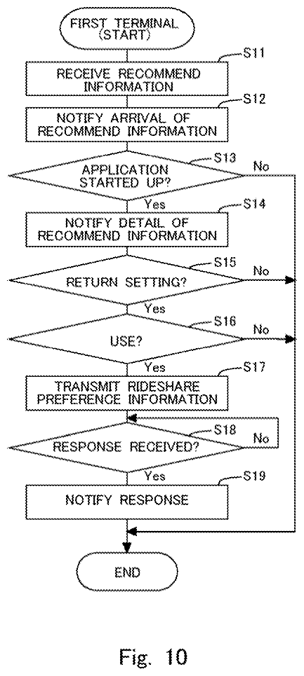

FIG. 10 is a flowchart illustrating the processing of the first terminal 20 when receiving the recommend information. The processing illustrated in FIG. 10 is executed by the control unit 221 (CPU 121) of the first terminal 20.

In S11, the control unit 221 acquires the recommend information received by the communication unit 224. In S12, the control unit 221 notifies the user that the recommend information has arrived. Notification is displayed on the display device 226 of the first terminal 20 for recommending the use of the rideshare service, for example. Such display can be implemented by applying push notification, for example. Further, a startup button of the rideshare application and the address (URL) of the download site of the rideshare application may be included in the display.

In S13, it is determining whether or not the rideshare application has been started up. A trigger for starting up the rideshare application may be a trigger input by the user or may be occurrence of an event (regardless of whether or not caused by on operation of the user) within the first terminal 20. For example, by taking a push of the startup button of the rideshare application by the user as a trigger, the control unit 201 starts up (starts to execute) the rideshare application, and detects the startup of the rideshare application.

When the rideshare application is not installed in the first terminal 20, the user performs a certain operation such as touching URL of the download site presented on the display described above. Upon that, the first terminal 20 access to the download site via the network 2. When the user operates the first terminal 20 according to a guidance of the download site, the first terminal 20 downloads a file of the rideshare application from the download site and installs to the first terminal 20. When the rideshare application is automatically started up by taking completion of installation as a trigger, the control unit 221 can detect such startup of the rideshare application. In this manner, through notifying the recommend information, installation of the rideshare application can be encouraged.

In S13, when the control unit 201 determines that the rideshare application is started up through detecting startup of the rideshare application, the processing is proceeded to S14. In the meantime, startup of the rideshare application is not detected when the user does not start up or install the rideshare application, so that the processing of FIG. 10 is ended.

In S14, the control unit 201 notifies the user about details of the recommend information through executing the rideshare application. For example, the control unit 201 displays various kinds of information (travel schedule that can be used for rideshare, use promotion information, information related to the car (car and driver attribute information), and the like included in the recommend information on the display device 226. When the information related to a plurality of cars 1 is included, the control unit 201 displays the information related to the cars 1 in a mode capable of making a selection from the cars 1. By referring to the recommend information, the user can be informed that the traveling in the own schedule can be done with rideshare and that there are economic effects, social contribution, and risk reduction effects, such as saving time and reduction in CO₂ produced amount by rideshare.

In S15, the control unit 221 determines whether or not return setting using the first terminal 20 is done. For example, the first terminal 20 carries out reception of the recommend information and notification to the user. In a mode where negotiation and coordination with the driver or the like of the car 1 are done by phone communication or the like contacted at the contact information included in the recommend information for the use of rideshare thereafter, there is no return setting done in the first terminal 20. When there is no return setting, the control unit 221 ends the processing. In the meantime, when there is return setting indicating preference to rideshare, the control unit 221 displays a screen on the display device 226 for asking the user whether or not to use the rideshare. When the user inputs to prefer the use of rideshare by using the input device 225, the processing is proceeded to S17. In the meantime, when it is inputted not to prefer the use of rideshare, the control unit 221 ends the processing.

In S17, the control unit 221 generates rideshare preference information and transmits to the server 10. The rideshare preference information includes following information, for example.

(1) Indicating preference to the use of rideshare.

(2) Selection result of the car 1 when information of the plurality of cars 1 is displayed.

(3) Other information needed for a contract to use rideshare (contact information of the user, and the like).

(4) User ID, car ID (ID of the car selected by the user when there are a plurality of cars).

Thereafter, the control unit 221 waits for a reply for the rideshare preference information (S18) and, upon receiving the response, notifies (e.g., displays on the display device 226) the user about the information included in the response (e.g., a fact that rideshare preference is accepted, a fact that a contract for using rideshare is concluded, etc.) and ends the processing. When there is no response received even after a prescribed length of time, the control unit 201 executes prescribed error processing and ends the processing.

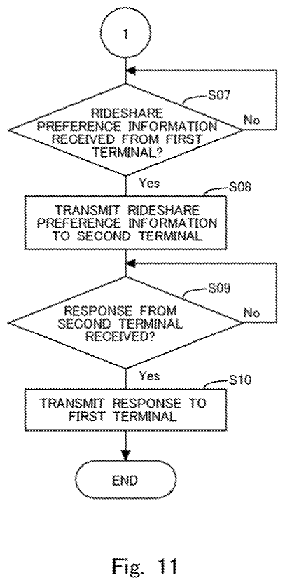

After transmitting the recommend information, the control unit 201 of the server 10 waits for the rideshare preference information as in S07 of FIG. 11. However, when there is no response received even after a prescribed length of time, the processing of FIG. 11 is ended. When the rideshare preference information is received, the control unit 201 transmits the rideshare preference information to the first terminal 20 by using the second terminal information in the car DB 152 (S08).

Thereafter, the control unit 201 waits for a response for the rideshare preference information from the second terminal 30 (S09) and, upon receiving the response, transmits the response to the first terminal 20 (S10).

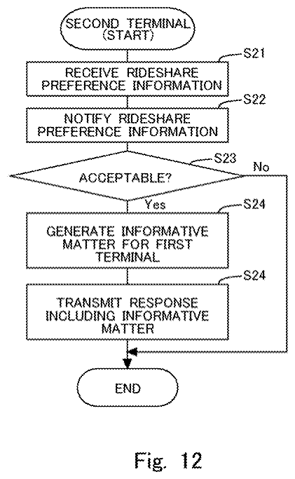

FIG. 12 is a flowchart illustrating a processing example of the second terminal 30. The processing of FIG. 12 is executed by the control unit 231 of the second terminal 30. In S21, the control unit 231 acquires the rideshare preference information received by the communication unit 234.

In S22, the control unit 231 notifies the user about arrival of the rideshare preference information. Notification may be done by displaying the information included in the rideshare preference information on the display device 236 of the second terminal 30, for example.

The control unit 231 displays a screen on the display device 236 for encouraging to enter an input indicating whether or not to accept rideshare preference. In S23, the user (driver or caretaker of the car 1) of the second terminal 30 enters an input indicating whether or not the rideshare preference is acceptable by using the input device 235. When there is an input indicating to be acceptable (Yes in S23), the control unit 231 generates informative matters (a fact that the rideshare preference is accepted, a fact that a contract is concluded, contact information for the car 1, etc.) for the user of the first terminal 20 (S24), and transmits a response including the informative matters to the server 10. The server 10 receives the response and transmits to the first terminal 20 as described above (S09, S10).

<Effects of First Embodiment>

As described above, the user with no actual use experience among the users of the rideshare service is extracted from the user DB, and the car 1 that can be used for the travel plan (schedule) of the extracted user is searched by using the information stored in the car DB 152. When the car 1 that can be used is searched (exists), the information recommending the use of rideshare (recommend information) is transmitted to the first terminal 20 of the user. The user considers the use of rideshare based on the recommend information and, returns the rideshare preference information when using rideshare. Thereby, expansion in the use of rideshare can be achieved.

### Second Embodiment

Hereinafter, a second embodiment will be described. The second embodiment has components in common to the first embodiment, so that mainly different components will be described and explanations of the common components will be omitted.

In the first embodiment, the user who has not installed the rideshare application and the user corresponding to “NAU” are treated as the users with no actual experience. In the second embodiment, whether or not there is actual experience in the use of rideshare is determining not based on whether the rideshare application is installed or whether there is a use history of the rideshare application but based on “travel history”.

As described in the first embodiment, the control unit 201 of the server 10 communicates with the first terminal 20 regularly or periodically and receives the position of the first terminal 20 (acquired by the position detection unit 228) from the first terminal 20. The control unit 201 acquires and records the travel distance and traveling speed from the position of this time and the position of previous time. As described, the server 10 acquires “travel history” of the first terminal 20, i.e., the information indicating the travel route (changes in position coordinates) and the traveling speed.

The memory unit 202 of the server 10 stores data (referred to as travel pattern information) indicating patterns of travel route and traveling speed in accordance with the traveling methods. The travel pattern information is generated by using map data and the like including home address of the user, location of garage of the private car, roads, places (train stations, bus stops, taxi stands) for getting on and off public transportations (train, bus, taxi), running routes of trains and buses, and the like.

The travel pattern information indicates the patterns according to means for traveling. For example, the travel pattern indicating traveling by walking or by a non-motorized car indicates a pattern where traveling continues at a traveling speed within a range not exceeding a prescribed speed. Further, the travel pattern indicating traveling by the private car indicates a pattern where the travel route goes through the position of the garage, stops there once, and the traveling speed is increased rapidly to a prescribed speed or more, for example. Further, the travel pattern indicating traveling by train or bus indicates a pattern where the travel route stops once at the places (train stations, bus stops) for getting on and off where the train or the bus stops, starts traveling at the traveling speed of the train or bus, and repeats to stop once at the train stations or the bus stations. Further, the travel pattern using a taxi can be defined as follows, for example. In general, places for getting on the taxies limited to some extent (taxi stands, on main streets, near home). Thus, the travel pattern using a taxi indicates a pattern where the travel route stops once at a typical place for getting on a taxi, and thereafter the traveling speed is increased rapidly to a prescribed speed or more.

The travel pattern using rideshare is a pattern other than the patterns described above. For example, the travel pattern using rideshare is a pattern where a stop is made once at a place more distant from the location of home or garage than a prescribed distance (e.g., for avoiding the home address to be known to fellow passengers) and a place different from the typical place for getting on the taxi (e.g., place other than somewhere on the road, such as parking space of a shop or facility), and the traveling speed is increased rapidly to a prescribed speed or more.

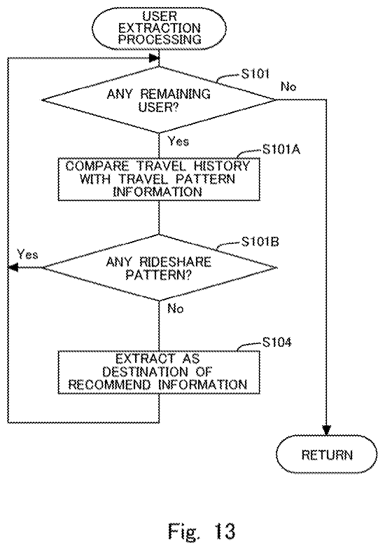

FIG. 13 illustrates user extraction processing of the second embodiment. A difference with respect to the first embodiment (FIG. 8) is that processing of S101A and S101B is provided instead of S102 and S103.

In S101A, the control unit 201 compares the travel history in the record of the user with the travel pattern information about each kind of means for traveling. In S101B, the control unit 201 determines whether or not the travel history includes the rideshare pattern as a result of comparison. When determining that the travel history includes the rideshare pattern (Yes in S101B), it is considered that the user has actual experience of rideshare. Thereby, the processing is returned to S101. In the meantime, when determining that the travel history includes no rideshare pattern (No in S101B), it is considered that the user has no actual experience of rideshare. Thereby, the processing is proceeded to S104.

In this manner, it is possible to determine whether or not the user has actual experience in the use of rideshare by using the travel history of the user. That is, the control unit 201 determines that the user has no actual experience in the use of rideshare when the information indicating the position history of the first terminal 20 does not indicate behaviors of the user observed when using rideshare. The configuration of the first embodiment and the configuration of the second embodiment are the same except for the above-described points, so that explanations are omitted. In the first embodiment, the processing of S101A and S101B may be executed when the information corresponding to “application” and “AU/NAU” for a certain user is not recorded. It is possible with the second embodiment to achieve working effects similar to the effects of the first embodiment.

The processing and means described in the first and second embodiment can be implemented in combination in a flexible manner as long as there is no technical confliction. Further, the processing described to be performed by a single device may be allotted and executed by a plurality of devices. Also, the processing described to be performed by different devices may be executed by a single device. In a computer system, it is possible to flexibly change the hardware configuration (server configuration) for implementing each function.

The server 10, the first terminal 20, and the second terminal 30 according to the first and second embodiments can also be implemented by supplying a computer program having the functions described in the embodiments to a computer and reading out and executing the program by one or more processor of the computer. Such computer program may be provided to the computer by a non-transitory computer readable medium connectable to the system of the computer or may be supplied via a network. Examples of the non-transitory computer readable medium may be any types of disks such as magnetic disks (Floppy® disk, hard disk drive (HDD), etc.) and optical disks (CD-ROM, DVD disk, Blu-ray Disc, etc.), read only memory (ROM), random access memory (RAM), EPROM, EEPROM, magnetic card, flash memory, optical card, and any types of media suited for storing electronic instructions.

What is claimed is:

1. An information processing apparatus comprising a controller that executes:
acquisition of information indicating a travel plan of a user and information indicating a driving schedule of a car available for use of rideshare; and
transmission of information recommending the use of the rideshare to a terminal of the user when determining that the travel plan of the user is executable by the use of the rideshare using the car based on the information indicating the travel plan of the user and the information indicating the driving schedule of the car.

2. The information processing apparatus according to claim 1, wherein the controller acquires the information indicating the travel plan of the user and the information indicating the driving schedule of the car when actual experience information indicating whether the user has actual experience in the use of the rideshare indicates that the user has no actual experience in the use of the rideshare.

3. The information processing apparatus according to claim 2, wherein:
the actual experience information is information indicating whether or not software related to the use of the rideshare is installed in the terminal or indicating whether or not there is an actual use experience of the software installed in the terminal; and
the controller determines that the user has no actual experience in the use of rideshare when the actual experience information indicates that the software is not installed in the terminal or indicates that there is no actual use experience of the software.

4. The information processing apparatus according to claim 3, wherein the controller transmits, to the terminal, the information recommending the use of the rideshare and information encouraging to install the software when the software is not installed in the terminal.

5. The information processing apparatus according to claim 2, wherein:
the actual experience information is information indicating a history of positions of the terminal; and
the controller determines that the user has no actual experience in the use of the rideshare, when the information indicating the history of the positions of the terminal does not indicate a behavior of the user observed in the use of the rideshare.

6. The information processing apparatus according to claim 1, wherein the controller extracts the actual experience information of each of members of a prescribed group from a database accumulating information related to the use of the rideshare regarding each of the members.

7. The information processing apparatus according to claim 1, wherein the controller acquires the information indicating the travel plan of the user from the terminal.

8. The information processing apparatus according to claim 1, wherein the controller acquires information indicating a history of positions of the terminal from the terminal and generates the information indicating the travel plan of the user by using the information indicating the history of the positions of the terminal.

9. The information processing apparatus according to claim 6, wherein the group is a group of owners of private cars; and
the car is the private car of the member.

10. The information processing apparatus according to claim 1, wherein the controller transmits information indicating a social contribution of the user, an economic effect the user can enjoy, and a risk the user can decrease by the use of the rideshare along with the information recommending the use of the rideshare.

11. The information processing apparatus according to claim 1, wherein the controller transmits information related to the car along with the information recommending the use of the rideshare.

12. An information processing method comprising:
acquiring information indicating a travel plan of a user and information indicating a driving schedule of a car available for use of rideshare; and
transmitting information recommending the use of the rideshare to a terminal of the user when determining that the travel plan of the user is executable by the use of the rideshare using the car based on the information indicating the travel of the user and the information indicating the driving schedule of the car.

13. A non-transitory storage medium stored with a program,
the program for causing a computer to:
acquire information indicating a travel plan of a user and information indicating a driving schedule of a car available for use of rideshare; and
transmit information recommending the use of rideshare to a terminal of the user when determining that the travel plan of the user is executable by the use of the rideshare using the car based on the information indicating the travel of the user and the information indicating the driving schedule of the car.
